(19) United States
(12) Patent Application Publication
(10) Pub. No.: US 2022/0186409 A1
(43) Pub. Date: Jun. 16, 2022

(54) WEAVED FABRIC, WEAVING METHOD, AND SOFT COMPONENT OF A SPEAKER MADE BY THE WEAVED FABRIC OR A FABRIC WEAVED BY THE WEAVING METHOD

(71) Applicant: Miao Tien Hsieh, Changhua County (TW)

(72) Inventor: Miao Tien Hsieh, Changhua County (TW)

(21) Appl. No.: 17/122,283

(22) Filed: Dec. 15, 2020

(51) Int. Cl. D03D 13/00; D03D 15/40; H04R 1/02

(52) U.S. Cl. CPC D03D 13/004; D03D 15/40; H04R 2400/11; D10B 2503/00; H04R 1/023

(57) ABSTRACT

A weaved fabric, a weaving method, and a soft component of a speaker made from the weaved fabric or fabric manufactured by the weaving method are provided. The weaved fabric has multiple larger meshes and multiple smaller meshes and each one of the larger meshes is surrounded by six smaller meshes. The weaving method can manufacture a fabric with the larger meshes and the smaller meshes. With the yarns forming the larger meshes and the smaller meshes and the larger meshes and the smaller meshes forming a resilience structure, the resilience and evenness of the fabrics are improved and the porosity of the fabrics is higher. Therefore, with a soft component made from the fabrics, tensions on the fabrics may keep even during working, and the amplitudes in the positive direction and the negative direction are more symmetrical.

### BACKGROUND OF THE INVENTION

### 1. Field of the Invention

The present invention relates to a weaved fabric and a weaving method for fabrics, especially to a weaved fabric and a weaving method for manufacturing a soft component of a speaker.

### 2. Description of the Prior Arts

Components of a speaker may be divided into two sorts, hard components and soft components. Hard components are made from unbendable or rigidity materials, e.g., a magnet, a U yoke, a T yoke, a basket/frame, a housing, etc. The soft components are made from bendable or resilience materials, e.g., a spider, a surround, a diaphragm, a dust cap, a cone paper, etc. Because the speaker generates sound mainly via the soft components, the soft component affects the sound quality very much.

Conventionally, the spider, the surround, the diaphragm, the dust cap, and the cone paper are made from a plain weaved fabric through a thermoforming process so as to shape a suitably curved surface.

The plain weaved fabric is not resilient. Though the thermoforming process may not break yarns of the plain weaved fabric, internal stress in the plain weaved fabric may be uneven or may be concentrated at specific positions. In other words, during sound making, the soft component made from the plain weaved fabric cannot be stretched evenly in every direction, so the quality of the generated sound nonlinear distortion is significant, especially at the frequency lower than the lowest resonance frequency. Besides, during manufacturing of a soft component from a fabric, the fabric may be soaked in phenolic resin and then undergo the thermoforming process to shape the fabric, and thereby the soft component may have rigidity and hardness. Besides, during working, the soft component may be vibrated, but because the plain weaved fabric is not resilient, the cured resin on the new soft component may be broken during vibration. Thus, a new speaker may generate significant noise.

FIG. 7 is an examination graph of a spider made from a plain weaved fabric, which shows frequency and amplitude relation. FIG. 8 is an examination graph of a spider made from a conventional weaved fabric, which also shows frequency and amplitude relation. These two examinations are executed under a test instrument made by Klippel Co., Germany. In the diagrams, the amplitude difference between the positive direction and the negative direction at the same frequency is larger, and the distortion of the sound is more significant. Besides, if the amplitudes are larger, the low frequency quality is better. As a result, according to FIG. 7 and FIG. 8, the amplitudes are less than 4 mm at almost every frequency and the amplitudes in the positive direction and the negative direction are not symmetrical. Sounds generated by such speaker may not have high quality and may be distorted significantly.

To overcome the shortcomings, the present invention provides a weaving method, a weaved fabric, and a soft component to mitigate or obviate the aforementioned problems.

### SUMMARY OF THE INVENTION

The main objective of the present invention is to provide a weaving method, a weaved fabric, and a soft component that can be used on a speaker, and thereby the speaker may provide sound with higher sound quality and lower sound distortion.

The weaving method includes steps in sequence as follows: a preparatory step, a weaving step, and an ending step. In the preparatory step, multiple first yarns are respectively connected to a crochet number 0, a crochet number 2, . . . and a crochet number 2k of a weaving machine and multiple second yarns are respectively connected to a crochet number 1, a crochet number 3, . . . and a crochet number 2k+1 of the weaving machine; wherein k is an integer. The weaving step includes eight movements in sequences that are respectively a first movement to an eighth movement. In the first movement, the first yarn on the crochet number 0 is transferred to the crochet number 1, the first yarn on the crochet number 2 is transferred to the crochet number 3, . . . and the first yarn on the crochet number 2k is transferred to the crochet number 2k+1; meanwhile, the second yarn on the crochet number 1 is transferred to the crochet number 0, the second yarn on the crochet number 3 is transferred to the crochet number 2, . . . and the second yarn on the crochet number 2k+1 is transferred to the crochet number 2k. In the second movement, the first yarn on the crochet number 1 is transferred to the crochet number 2, the first yarn on the crochet number 3 is transferred to a crochet number 4, . . . and the first yarn on the crochet number 2k+1 is transferred to a crochet number 2k+2; meanwhile, the second yarn on the crochet number 0 is transferred to a crochet number −1, the second yarn on the crochet number 2 is transferred to the crochet number 1 . . . , and the second yarn on the crochet number 2k is transferred to a crochet number 2k−1. In the third movement, the first yarn on the crochet number 2 is transferred to the crochet number 3, the first yarn on the crochet number 4 is transferred to a crochet number 5 . . . , and the first yarn on the crochet number 2k+2 is transferred to a crochet number 2k+3; meanwhile, the second yarn on the crochet number −1 is transferred to a crochet number −2, the second yarn on the crochet number 1 is transferred to the crochet number 0 . . . , and the second yarn on the crochet number 2k−1 is transferred to a crochet number 2k−2. In the fourth movement, the first yarn on the crochet number 3 is transferred to the crochet number 4, the first yarn on the crochet number 5 is transferred to a crochet number 6 . . . , and the first yarn on the crochet number 2k+3 is transferred to a crochet number 2k+4; meanwhile, the second yarn on the crochet number −2 is transferred to a crochet number −3, the second yarn on the crochet number 0 is transferred to the crochet number −1 . . . , and the second yarn on the crochet number 2k−2 is transferred to a crochet number 2k−3. In the fifth movement, the first yarn on the crochet number 4 is transferred to the crochet number 3, the first yarn on the crochet number 6 is transferred to the crochet number 5 . . . , and the first yarn on the crochet number 2k+4 is transferred to the crochet number 2k+3; meanwhile, the second yarn on the crochet number −3 is transferred to the crochet number −2, the second yarn on the crochet number −1 is transferred to the crochet number 0 . . . , and the second yarn on the crochet number 2k−3 is transferred to the crochet number 2k−2. In the sixth movement, the first yarn on the crochet number 3 is transferred to the crochet number 2, the first yarn on the crochet number 5 is transferred to the crochet number 4 . . . , and the first yarn on the crochet number 2k+3 is transferred to the crochet number 2k+2; meanwhile, the second yarn on the crochet number −2 is transferred to the crochet number −1, the second yarn on the crochet number 0 is transferred to the crochet number 1 . . . , and the second yarn on the crochet number 2k−2 is transferred to the crochet number 2k−1. In the seventh movement: the first yarn on the crochet number 2 is transferred to the crochet number 1, the first yarn on the crochet number 4 is transferred to the crochet number 3 . . . , and the first yarn on the crochet number 2k+2 is transferred to the crochet number 2k+1; meanwhile, the second yarn on the crochet number −1 is transferred to the crochet number 0, the second yarn on the crochet number 1 is transferred to the crochet number 2 . . . , and the second yarn on the crochet number 2k−1 is transferred to the crochet number 2k. In the eighth movement: the first yarn on the crochet number 1 is transferred to the crochet number 0, the first yarn on the crochet number 3 is transferred to the crochet number 2 . . . , and the first yarn on the crochet number 2k+1 is transferred to the crochet number 2k; meanwhile, the second yarn on the crochet number 0 is transferred to the crochet number 1, the second yarn on the crochet number 2 is transferred to the crochet number 3 . . . , and the second yarn on the crochet number 2k is transferred to the crochet number 2k+1. In the ending step after performing the weaving step several times, finish weaving and cutting the first yarns and the second yarns to form a weaved fabric.

The weaved fabric comprises a plurality of larger meshes and a plurality of smaller meshes. Each two adjacent ones of the larger meshes are spaced at a first interval. Each two adjacent ones of the smaller meshes are spaced at a second interval. Dimensions of each one of the smaller meshes are smaller than dimensions of each one of the larger meshes and each one of the larger meshes is surrounded by six of the smaller meshes.

The soft component comprises the aforesaid weaved fabric.

Consequently, in the weaved fabric of the present invention or the fabric made from the weaving method of the present invention, yarns form the larger meshes and the smaller meshes, and the larger meshes and the smaller meshes form a resilience structure. The resilience and evenness of said fabrics are improved and the porosity of said fabrics is higher. Therefore, with a soft component made from said fabrics, tensions and deformations thereon may keep even during working, the amplitudes are higher and the amplitudes in the positive direction and the negative direction are more symmetrical, the deformation is not significant after working for a long time and under high power, the speaker may achieve lower low-frequency resonance, and airflow sound at low frequency and high amplitude may be decreased. In other words, the quality of the speaker is improved in various aspects.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a speaker;

FIG. 2 shows a structure unit of the weaved fabric in accordance with the present invention;

FIG. 3 is a perspective view showing a weaving method in accordance with the present invention;

FIG. 4 is another perspective view showing the weaving method in FIG. 3 shown with larger meshes and smaller meshes;

FIG. 5 is a schematic view of a fabric made by the weaving method in FIG. 3;

FIG. 6 is an examination graph of a spider made from the fabric made by the weaving method in FIG. 3;

FIG. 7 is an examination graph of a spider made from a conventional plain weaved fabric; and

FIG. 8 is an examination graph of a spider made from another conventional weaved fabric.

### DETAILED DESCRIPTION OF THE PREFERRED EMBODIMENTS

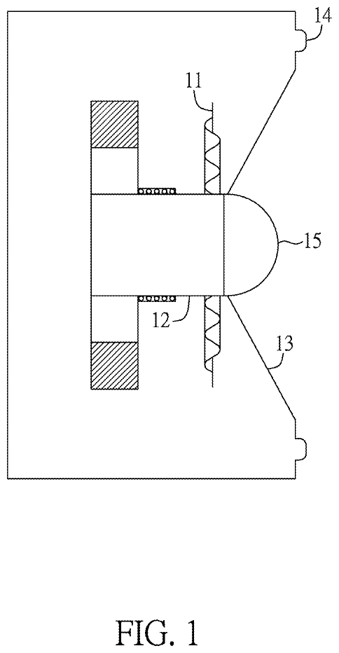

With reference to FIG. 1, soft components of a speaker may comprise a spider 11, a voice coil 12, a diaphragm 13, a surround 14, a dust cap 15, etc. In the present invention, the soft components are made of a specific weaved fabric through a thermoforming process.

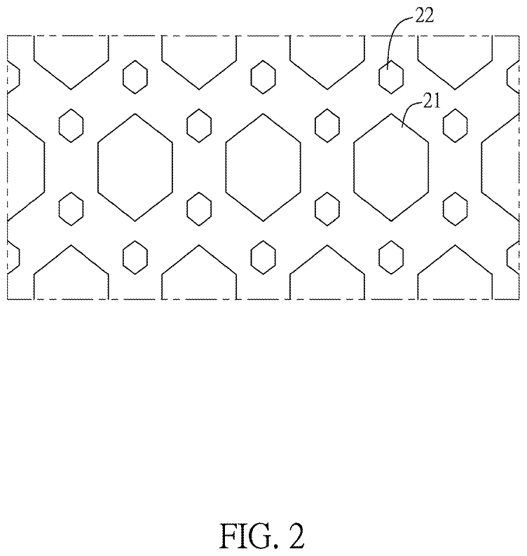

Then please refer to FIG. 2. A weaved fabric provided according to the present invention includes a plurality of larger meshes 21 spaced apart from each other at a first interval and a plurality of smaller meshes 22 spaced apart from each other at a second interval. The larger meshes 21 and the smaller meshes 22 may be hexagons as shown in the drawings because yarns of the weaved fabric are weaved into hexagons and nodes of the yarns are located at corners of the hexagons. In this embodiment, each one of the larger meshes 21 is surrounded by six of the smaller meshes 22.

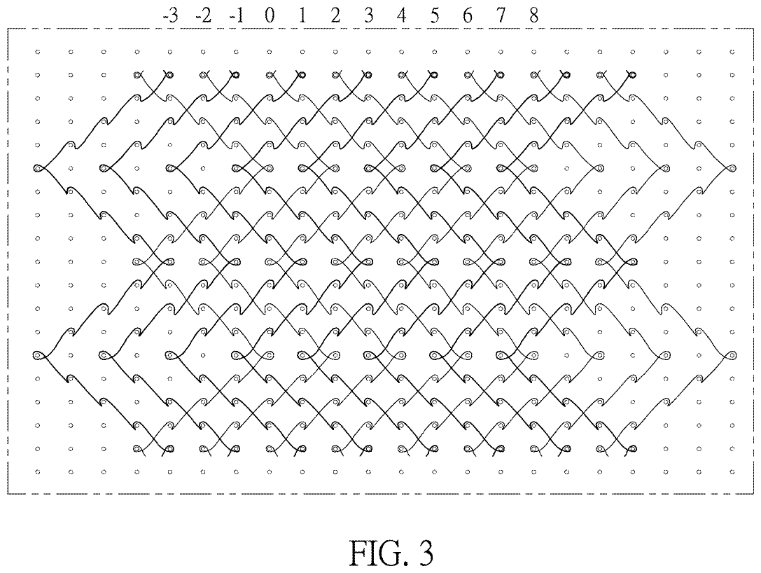

Then please refer to FIG. 3 to FIG. 5. Said weaved fabric may be weaved by a weaving method according to the present invention. However, it is not limited thereto, as said weaved fabric may be weaved by any other weaving method as long as the structure thereof is the same. The weaving method of the present invention includes the following steps in sequence: a preparatory step, at least one weaving step, and an ending step. In fact, there are multiple identical weaving steps repeatedly performed between the preparatory step and the ending step.

The preparatory step includes the following movements: a plurality of first yarns are respectively connected to a crochet number 0, a crochet number 2 . . . , and a crochet number 2k of a weaving machine, and a plurality of second yarns are respectively connected to a crochet number 1, a crochet number 3 . . . , and a crochet number 2k+1 of the weaving machine. The parameter “k” is an integer. The numbers of the crochets may be increased from left to right, but also may be increased from right to left.

Actually, during execution of the preparatory step, the first yarns and the second yarns are mounted on the crochets from small to large ordinals and staggered, i.e., one of the first yarns is mounted on the crochet number 0, one of the second yarns is mounted on the crochet number 1, one of the first yarns is mounted on the crochet number 2, one of the second yarns is mounted on the crochet number 3, . . . and another one of the first yarns is mounted on the crochet number 2k, another one of the second yarns is mounted on the crochet number 2k+1, etc.

In the ending step, after the multiple weaving steps are completed, the weaved yarns are finished and cut and thereby form a weaved fabric.

The weaving step includes a first movement to an eighth movement as disclosed below.

In the first movement, the first yarn on the crochet number 0 is transferred to the crochet number 1, the first yarn on the crochet number 2 is transferred to the crochet number 3, . . . and the first yarn on the crochet number 2k is transferred to the crochet number 2k+1 . . . ; meanwhile, the second yarn on the crochet number 1 is transferred to the crochet number 0, the second yarn on the crochet number 3 is transferred to the crochet number 2, . . . and the second yarn on the crochet number 2k+1 is transferred to the crochet number 2k, etc. Actually, when the first movement is being executed, the first yarns and the second yarn are transferred on the crochets from small to large ordinals and staggered, rather than the first yarns are transferred completely and then the second yarns are transferred. In other words, after one first yarn is transferred, one second yarn is transferred immediately; after one second yarn is transferred, one first yarn is transferred immediately; the following movements are the same.

In the second movement, the first yarn on the crochet number 1 is transferred to the crochet number 2, the first yarn on the crochet number 3 is transferred to the crochet number 4, . . . and the first yarn on the crochet number 2k+1 is transferred to the crochet number 2k+2; meanwhile, the second yarn on the crochet number 0 is transferred to the crochet number −1, the second yarn on the crochet number 2 is transferred to the crochet number 1, . . . and the second yarn on the crochet number 2k is transferred to the crochet number 2k−1, etc.

In the third movement, the first yarn on the crochet number 2 is transferred to the crochet number 3, the first yarn on the crochet number 4 is transferred to the crochet number 5, . . . and the first yarn on the crochet number 2k+2 is transferred to the crochet number 2k+3; meanwhile, the second yarn on the crochet number −1 is transferred to the crochet number −2, the second yarn on the crochet number 1 is transferred to the crochet number 0, . . . and the second yarn on the crochet number 2k−1 is transferred to the crochet number 2k−2, etc.

In the fourth movement, the first yarn on the crochet number 3 is transferred to the crochet number 4, the first yarn on the crochet number 5 is transferred to the crochet number 6, . . . and the first yarn on the crochet number 2k+3 is transferred to the crochet number 2k+4; meanwhile, the second yarn on the crochet number −2 is transferred to the crochet number −3, the second yarn on the crochet number 0 is transferred to the crochet number −1, . . . and the second yarn on the crochet number 2k−2 is transferred to the crochet number 2k−3, etc.

In the fifth movement, the first yarn on the crochet number 4 is transferred to the crochet number 3, the first yarn on the crochet number 6 is transferred to the crochet number 5, . . . and the first yarn on the crochet number 2k+4 is transferred to the crochet number 2k+3; meanwhile, the second yarn on the crochet number −3 is transferred to the crochet number −2, the second yarn on the crochet number −1 is transferred to the crochet number 0, . . . and the second yarn on the crochet number 2k−3 is transferred to the crochet number 2k−2, etc.

In the sixth movement, the first yarn on the crochet number 3 is transferred to the crochet number 2, the first yarn on the crochet number 5 is transferred to the crochet number 4, . . . and the first yarn on the crochet number 2k+3 is transferred to the crochet number 2k+2; meanwhile, the second yarn on the crochet number −2 is transferred to the crochet number −1, the second yarn on the crochet number 0 is transferred to the crochet number 1, . . . and the second yarn on the crochet number 2k−2 is transferred to the crochet number 2k−1, etc.

In the seventh movement, the first yarn on the crochet number 2 is transferred to the crochet number 1, the first yarn on the crochet number 4 is transferred to the crochet number 3, . . . and the first yarn on the crochet number 2k+2 is transferred to the crochet number 2k+1; meanwhile, the second yarn on the crochet number −1 is transferred to the crochet number 0, the second yarn on the crochet number 1 is transferred to the crochet number 2, . . . and the second yarn on the crochet number 2k−1 is transferred to the crochet number 2k, etc.

In the eighth movement, the first yarn on the crochet number 1 is transferred to the crochet number 0, the first yarn on the crochet number 3 is transferred to the crochet number 2, . . . and the first yarn on the crochet number 2k+1 is transferred to the crochet number 2k; meanwhile, the second yarn on the crochet number 0 is transferred to the crochet number 1, the second yarn on the crochet number 2 is transferred to the crochet number 3, . . . and the second yarn on the crochet number 2k is transferred to the crochet number 2k+1, etc.

Briefly, in the first to fourth movements, the first yarns are transferred to the larger ordinal of the crochet by one and the second yarns are transferred to the smaller ordinal of the crochet by one. Thus, after the fourth movement is completed, each one of the first yarns is transferred to the larger ordinal of the crochet by four (e.g., the first yarn on the crochet number 0 is transferred to the crochet number 4 in sequence, or the first yarn on the crochet number 2k is transferred to the crochet number 2k+4 gradually). Meanwhile, after the fourth movement is completed, each one of the second yarns is transferred to the smaller ordinal of the crochet by four (e.g., the second yarn on the crochet number 1 is transferred to the crochet number −3 in sequence, or the first yarn on the crochet number 2k+1 is transferred to the crochet number 2k−3 gradually).

In the fifth to eighth movements, the transferring is executed backwards, i.e., the first yarns are transferred to the smaller ordinal crochet by one and the second yarns are transferred to the larger ordinal crochet by one. Thus, after the eighth movement is completed, each one of the first yarns is transferred to the smaller ordinal of the crochet by four (e.g., the first yarn on the crochet number 4 is transferred to the crochet number 0 in sequence, or the first yarn on the crochet number 2k+4 is transferred to the crochet number 2k gradually). Meanwhile, after the eighth movement is completed, each one of the second yarns is transferred to the larger ordinal of the crochet by four (e.g., the second yarn on the crochet number −3 is transferred to the crochet number 1 in sequence, or the first yarn on the crochet number 2k−3 is transferred to the crochet number 2k+1 gradually). In other words, each one of the first yarns and the second yarns is transferred to the original crochet.

From the first movement to the second movement, from the second movement to the third movement, from the third movement to the fourth movement, from the fifth movement to the sixth movement, from the sixth movement to the seventh movement, and from the seventh movement to the eighth movement, the transfer direction is from bottom to top. From the fourth movement to the fifth movement and from the eighth movement to the first movement of the next weaving step, the transfer is executed on an upper side.

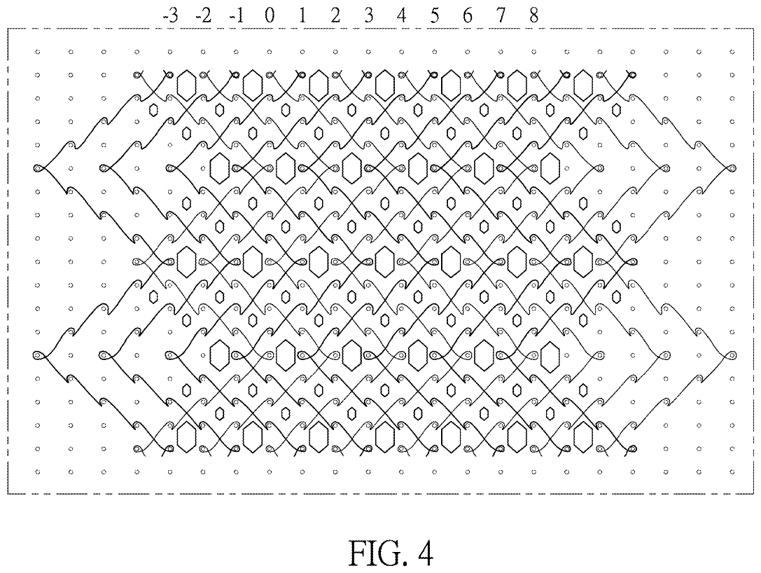

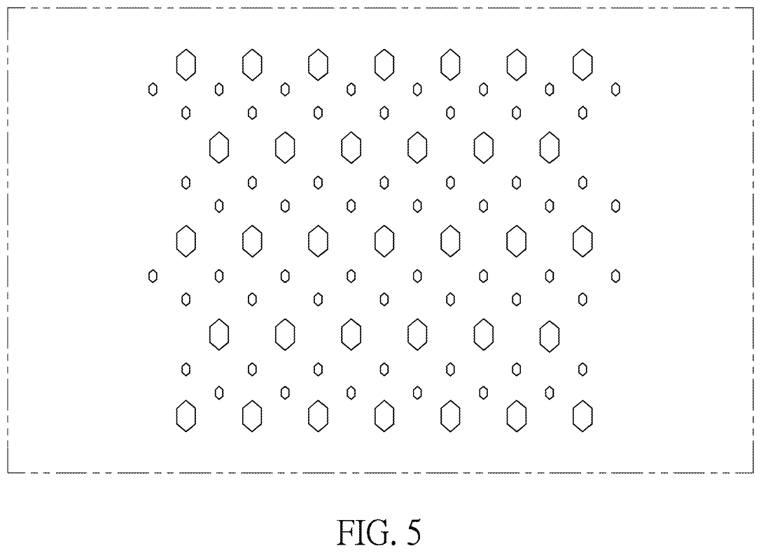

Then please refer to FIG. 2, FIG. 4, and FIG. 5. With the weaving method provided by the present invention, after the second movement, the smaller meshes 22 are formed between the crochet number 0 and the crochet number 1, between the crochet number 2 and the crochet number 3, . . . and between crochet number 2k and the crochet number 2k+1, etc.

After the third movement, the smaller meshes 22 are formed between the crochet number 1 and the crochet number 2, between the crochet number 3 and the crochet number 4, . . . and between the crochet number 2k+1 and the crochet number 2k+2, etc.

After the fourth movement and the fifth movement, the larger meshes 21 are formed between the crochet number 0 and the crochet number 1, between the crochet number 2 and the crochet number 3, . . . and between the crochet number 2k and the crochet number 2k+1, etc.

After the sixth movement, the smaller meshes 22 are formed between the crochet number 1 and the crochet number 2, between the crochet number 3 and the crochet number 4, . . . and between the crochet number 2k+1 and the crochet number 2k+2, etc.

After the seventh movement, the smaller meshes 22 are formed between the crochet number 0 and the crochet number 1, between the crochet number 2 and the crochet number 3, . . . and between the crochet number 2k and the crochet number 2k+1, etc.

After the eighth movement and the first movement of the next weaving step, the larger meshes 21 are formed between the crochet number 1 and the crochet number 2, between the crochet number 3 and crochet number 4, . . . and between the crochet number 2k+1 and the crochet number 2k+2, etc.

Therefore, FIG. 5 shows an initial structure of a fabric newly made by the weaving method of the present invention. Then, because tensions of the first yarns and the second will be balanced by themselves, the structure of said fabric may change to as shown in FIG. 2. In the present invention, the weaved fabric or a soft component made from the weaved fabric may comprise the larger meshes 21 and the smaller mesh 22, so said weaved fabric or said soft component may comprise resin coated thereon, which keeps the larger meshes 21 and the smaller meshes 22 in loops and maintains resilience of the larger meshes 21 and the smaller meshes 22. Therefore, the speaker comprising said soft component may reduce the difference of the sound quality before and after warmed up, and thereby the time period of warming up is decreased. Besides, the loop shape of the larger meshes 21 and the smaller mesh 22 may prevent the cured resin from breaking, so the noise generated when the cured resin is broken is also decreased.

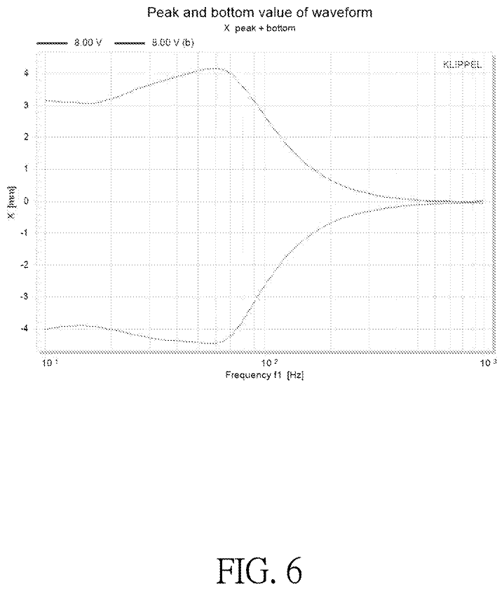

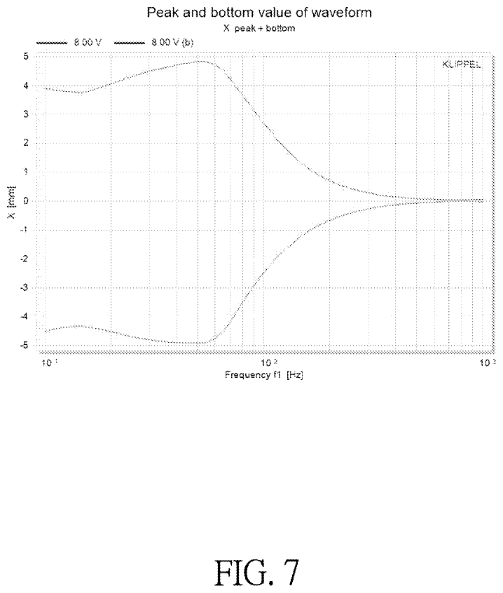

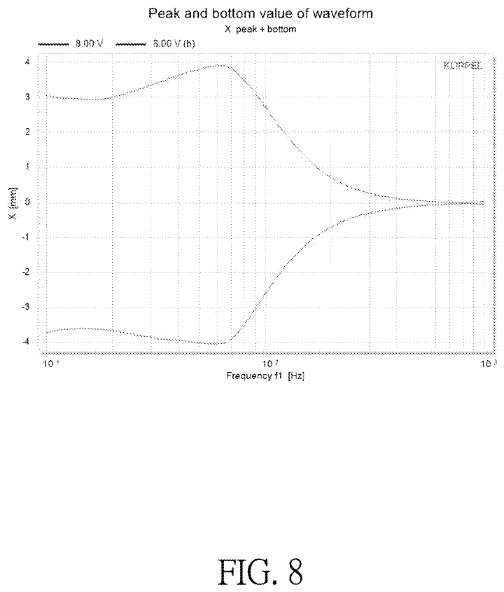

FIG. 6 is an examination graph of a spider made from the weaved fabric of the present invention, which shows frequency and amplitude relation according to a test instrument made by Klippel Co., Germany. Compared to FIG. 7 and FIG. 8, which are examination graphs of conventional spiders, the spider made from the weaved fabric of the present invention provides higher amplitudes at the same frequency, and the amplitudes in the positive direction and in the negative direction are more symmetrical.

Consequently, in the weaved fabric of the present invention or the fabric made from the weaving method of the present invention, a resilience structure is formed via the yarns forming the larger meshes 21 and the smaller meshes 22, so the resilience and evenness of said fabrics are improved. Besides, because the porosity of said fabrics is higher, said fabrics further provide higher breathability and lower wind resistance. Moreover, a soft component made from said fabrics has the following advantages: the deformation is uniform while undergoing external force, the amplitudes in positive and negative directions are more symmetrical, the amplitude is higher than that of the conventional soft component at the same power, the deformation is not significant after work for a long time and under high power, the compliance is good and thereby the distortion rate is low and the sound quality is clearer. Furthermore, the soft component made from said fabrics also has the following advantages: faster response, shorter delay, wider sound range, lesser noise, lower damping, higher heat dissipation, better fatigue resistance, higher rigidity, greater power capacity, better dynamic stability, etc., and thereby the quality of the speaker is improved in various aspects.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A weaving method including steps in sequence as follows:
a preparatory step: connecting multiple first yarns respectively to a crochet number 0, a crochet number 2, . . . and a crochet number 2k . . . of a weaving machine and connecting multiple second yarns respectively connected to a crochet number 1, a crochet number 3, . . . and a crochet number 2k+1 . . . of the weaving machine, wherein k is an integer;
a weaving step including movements in sequence as follows:
a first movement: transferring the first yarn on the crochet number 0 to the crochet number 1, transferring the first yarn on the crochet number 2 to the crochet number 3, . . . and transferring the first yarn on the crochet number 2k to the crochet number 2k+1; meanwhile, transferring the second yarn on the crochet number 1 to the crochet number 0, transferring the second yarn on the crochet number 3 to the crochet number 2, . . . and transferring the second yarn on the crochet number 2k+1 to the crochet number 2k;
a second movement: transferring the first yarn on the crochet number 1 to the crochet number 2, transferring the first yarn on the crochet number 3 to a crochet number 4, . . . and transferring the first yarn on the crochet number 2k+1 to a crochet number 2k+2; meanwhile, transferring the second yarn on the crochet number 0 to a crochet number −1, transferring the second yarn on the crochet number 2 to the crochet number 1 . . . , and transferring the second yarn on the crochet number 2k to a crochet number 2k−1;
a third movement: transferring the first yarn on the crochet number 2 to the crochet number 3, transferring the first yarn on the crochet number 4 to a crochet number 5 . . . , and transferring the first yarn on the crochet number 2k+2 to a crochet number 2k+3; meanwhile, transferring the second yarn on the crochet number −1 to a crochet number −2, transferring the second yarn on the crochet number 1 to the crochet number 0 . . . , and transferring the second yarn on the crochet number 2k−1 to a crochet number 2k−2;
a fourth movement: transferring the first yarn on the crochet number 3 to the crochet number 4, transferring the first yarn on the crochet number 5 to a crochet number 6 . . . , and transferring the first yarn on the crochet number 2k+3 to a crochet number 2k+4; meanwhile, transferring the second yarn on the crochet number −2 to a crochet number −3, transferring the second yarn on the crochet number 0 to the crochet number −1 . . . , and transferring the second yarn on the crochet number 2k−2 to a crochet number 2k−3;
a fifth movement: transferring the first yarn on the crochet number 4 to the crochet number 3, transferring the first yarn on the crochet number 6 to the crochet number 5 . . . , and transferring the first yarn on the crochet number 2k+4 to the crochet number 2k+3; meanwhile, transferring the second yarn on the crochet number −3 to the crochet number −2, transferring the second yarn on the crochet number −1 to the crochet number 0 . . . , and transferring the second yarn on the crochet number 2k−3 to the crochet number 2k−2;
a sixth movement: transferring the first yarn on the crochet number 3 to the crochet number 2, transferring the first yarn on the crochet number 5 to the crochet number 4 . . . , and transferring the first yarn on the crochet number 2k+3 to the crochet number 2k+2; meanwhile, transferring the second yarn on the crochet number −2 to the crochet number −1, transferring the second yarn on the crochet number 0 to the crochet number 1 . . . , and transferring the second yarn on the crochet number 2k−2 to the crochet number 2k−1;
a seventh movement: transferring the first yarn on the crochet number 2 to the crochet number 1, transferring the first yarn on the crochet number 4 to the crochet number 3 . . . , and transferring the first yarn on the crochet number 2k+2 to the crochet number 2k+1; meanwhile, transferring the second yarn on the crochet number −1 to the crochet number 0, transferring the second yarn on the crochet number 1 to the crochet number 2 . . . , and transferring the second yarn on the crochet number 2k−1 to the crochet number 2k; and
an eighth movement: transferring the first yarn on the crochet number 1 to the crochet number 0, transferring the first yarn on the crochet number 3 to the crochet number 2 . . . , and transferring the first yarn on the crochet number 2k+1 to the crochet number 2k; meanwhile, transferring the second yarn on the crochet number 0 to the crochet number 1, transferring the second yarn on the crochet number 2 to the crochet number 3 . . . , and transferring the second yarn on the crochet number 2k to the crochet number 2k+1; and
an ending step: after performing the weaving step several times, finishing weaving and cutting the first yarns and the second yarns to form a weaved fabric.

2. A weaved fabric comprising:
a plurality of larger meshes, each two adjacent ones of the larger meshes spaced at a first interval; and
a plurality of smaller meshes, each two adjacent ones of the smaller meshes spaced at a second interval; a dimension of each one of the smaller meshes being smaller than a dimension of each one of the larger meshes, and each one of the larger meshes surrounded by six of the smaller meshes.

3. The weaved fabric as claimed in claim 2, wherein each one of the smaller meshes is surrounded by three of the larger meshes and three of the smaller meshes and said three larger meshes and said three smaller meshes are staggered.

4. The weaved fabric as claimed in claim 2, wherein each two adjacent ones of the larger meshes are spaced by two of the smaller meshes.

5. A soft component of a speaker comprising a weaved fabric as claimed in claim 2.

6. The soft component as claimed in claim 5 being a spider, a surround, a diaphragm, a dust cap, or a cone paper.
